(19) United States
(12) Patent Application Publication
(10) Pub. No.: US 2026/0189655 A1
(43) Pub. Date: Jul. 2, 2026

(54) DYNAMIC AUTONOMOUS CONTACT CENTER SYSTEMS AND METHODS

(71) Applicant: UIPCO, LLC, San Antonio, TX (US)

(72) Inventors: Michael Patrick Bueche, JR., San Antonio, TX (US); Frederick Eugene Diehl, JR., Cibolo, TX (US); Andrew P. Jamison, San Antonio, TX (US); Gregory B. Yarbrough, San Antonio, TX (US)

(21) Appl. No.: 19/425,724

(22) Filed: Dec. 18, 2025

Related U.S. Application Data
(60) Provisional application No. 63/739,396, filed on Dec. 27, 2024.

(51) Int. Cl. H04M 3/51; G06F 40/20; H04M 3/523

(52) U.S. Cl. CPC H04M 3/5175; G06F 40/20; H04M 3/523

(57) ABSTRACT

An autonomous contact center system includes a computing system with one or more processors. The autonomous contact center system also includes memory storing instructions that, when executed by the computing system, cause the computing system to route a customer to an automated transaction agent; determine a task to complete based on a conversation between the customer and the automated transaction agent; instruct the automated transaction agent to request that the customer provide additional information relevant to the task; and in response to determining that the customer is unable to provide the additional information relevant to the task, provide an output to prompt a human input.

### CROSS-REFERENCE TO RELATED APPLICATION

This application claims priority to and the benefit of U.S. Provisional Application No. 63/739,396, entitled “DYNAMIC AUTONOMOUS CONTACT CENTER SYSTEMS AND METHODS” and filed Dec. 27, 2024, which is incorporated by reference herein in its entirety for all purposes.

### BACKGROUND

The present disclosure relates generally to dynamic engagement systems and methods, and more specifically to dynamic autonomous contact center systems and methods.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admission of prior art.

Modern businesses may offer customer service representatives (CSRs) that are available (e.g., by telephone) to assist customers with various tasks (e.g., open new accounts, submit complaints, update personal information) or to answer customer inquiries (e.g., questions regarding products offered by the business). However, because modern businesses are often diverse (e.g., having several different business operations, products, or services), it may be difficult for the CSRs to properly (e.g., sufficiently and/or efficiently) assist the customers and/or answer the customer inquiries.

### BRIEF DESCRIPTION

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In certain embodiments, an autonomous contact center system includes a computing system with one or more processors. The autonomous contact center system also includes memory storing instructions that, when executed by the computing system, cause the computing system to route a customer to an automated transaction agent; determine a task to complete based on a conversation between the customer and the automated transaction agent; instruct the automated transaction agent to request that the customer provide additional information relevant to the task; and in response to determining that the customer is unable to provide the additional information relevant to the task, provide an output to prompt a human input.

In certain embodiments, an autonomous contact center system includes a computing system with one or more processors. The autonomous contact center system also includes memory storing instructions that, when executed by the computing system, cause the computing system to route an automated customer associated with a human customer to an automated transaction agent, a human transaction agent, or both; determine a task to complete based on a conversation between the automated customer and the automated transaction agent, the human transaction agent, or both; and complete the task based on the conversation between the automated customer and the automated transaction agent, the human transaction agent, or both.

In certain embodiments, a method of operating an autonomous contact center system includes routing, using one or more processors, an automated customer to an automated transaction agent. The method also includes determining, using the one or more processors, a task to complete based on a conversation between the automated customer and the automated transaction agent. The method also includes instructing, using the one or more processors, the automated transaction agent to request that the automated customer provide additional information relevant to the task. The method further includes completing, using the one or more processors, the task based on the conversation and the additional information.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an autonomous contact center system with a contact center system that includes automated agents and human agents, in accordance with an embodiment;

FIG. 2 is a schematic diagram of the autonomous contact center system of FIG. 1, wherein the contact center system is configured to engage with a customer team that includes an automated customer and a human customer, in accordance with an embodiment;

FIG. 3 is a schematic diagram of the autonomous contact center system of FIG. 1, wherein the contact center system includes the automated agents and the human agents arranged in teams, in accordance with an embodiment;

FIG. 4 is a schematic diagram that represents an example conversation that may be carried out by the autonomous contact center system of FIG. 1, wherein a transaction team utilizes an automated transaction agent, a human transaction agent, or both to complete a task for a human customer of the customer team, in accordance with an embodiment;

FIG. 5 is a schematic diagram that represents an example conversation that may be carried out by the autonomous contact center system of FIG. 1, wherein the transaction team switches between the automated transaction agent and the human transaction agent to interact with the customer team, in accordance with an embodiment;

FIG. 6 is an example conversation that may be carried out by the autonomous contact center system of FIG. 1, wherein the transaction team utilizes the automated transaction agent, the human transaction agent, or both to interact with the automated customer of the customer team, in accordance with an embodiment;

FIG. 7 is a flow diagram of a method of operating an autonomous contact center system to route a customer to one or more automated agents, one or more human agents, or both based on conversation inputs, in accordance with an embodiment;

FIG. 8 is a flow diagram of a method of operating an autonomous contact center system to transfer a customer between an automated transaction agent and a human transaction agent to complete a task for the customer, in accordance with an embodiment; and

FIG. 9 is a flow diagram of a method of operating an autonomous contact center system to engage with an automated customer that is associated with a human customer, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” “having,” and “based on” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As noted above, modern businesses may offer customer service representatives (CSRs) to assist customers with various tasks and/or to answer customer inquiries. It is presently recognized that it may be desirable to implement an autonomous contact center that provides conversation-based assistance to customers, and that also provides dynamic engagement with the customers via multiple automated agents and multiple human agents. In certain embodiments, the multiple automated agents and the multiple human agents may be arranged in teams (e.g., peers) and may also be arranged in levels (e.g., transaction levels, expert levels). For example, a transaction team may include an automated transaction agent and a human transaction agent, an expert team may include an automated expert agent and a human expert agent, and the transaction team and the expert team may be trained on different information (e.g., training data sets). In certain embodiments, the autonomous contact center provides the conversation-based assistance and the dynamic engagement with an automated customer that is associated with a human customer. For example, the automated customer may include a virtual assistant for the human customer.

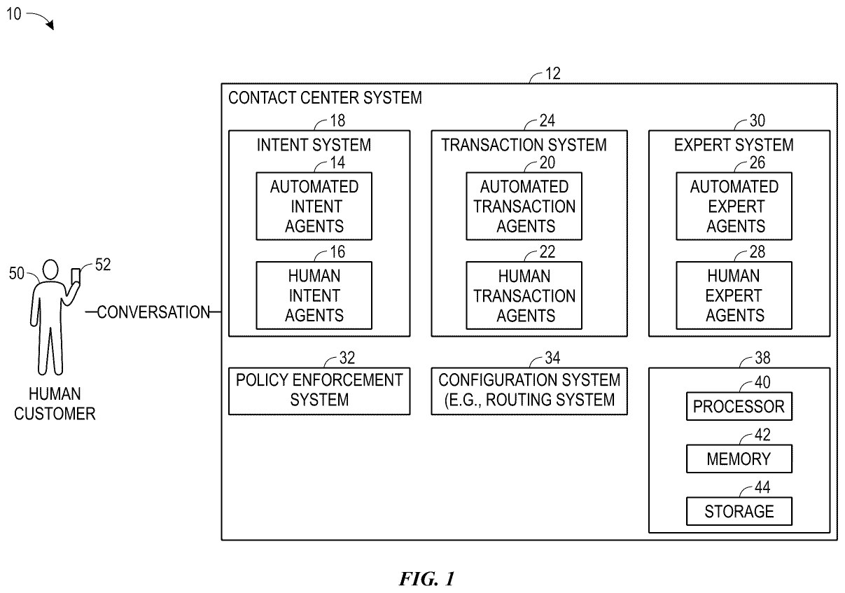

FIG. 1 is a schematic diagram of an autonomous contact center system 10 with a contact center system 12 that includes automated agents and human agents, in accordance with an embodiment. In certain embodiments, the contact center system 12 includes one or more automated intent agents 14 and one or more human intent agents 16 that may be considered to form or be part of an intent system 18. As shown, the contact center system 12 includes one or more automated transaction agents 20 and one or more human transaction agents 22 that may be considered to form or be part of a transaction system 24. As shown, the contact center system 12 includes one or more automated expert agents 26 and one or more human expert agents 28 that may be considered to form or be part of an expert system 30. It should be appreciated that these features are merely exemplary and the contact center system 12 may include any of a variety of automated agents, human agents, and so forth arranged in any of a variety of ways. Further, while the contact center system 12 is shown and described as including the human agents to facilitate discussion, it should be appreciated that the contact center system 12 more particularly includes respective equipment (e.g., microphones, speakers, keyboards, displays, personal computers) that enables the human agents to interact with the contact center system 12 (e.g., to receive outputs from and to provide inputs to the contact center system 12; to interact with the automated agents, other human agents, and customers via speaking into microphones, listening via speakers, typing via keyboards, viewing text via displays, and so forth).

In certain embodiments, the contact center system 12 includes a policy enforcement system 32. The policy enforcement system 32 may monitor conversations (e.g., verbal conversations and/or written messages) and may take actions to ensure the conversations comply with one or more policies (e.g., legal policies and/or corporate policies). The policy enforcement system 32 may, in real-time (e.g., in substantially real-time, such as within seconds or milliseconds; during the conversations), adjust the conversations, block certain portions of the conversations, and so forth. In this way, the contact center system 12 may provide appropriate information (e.g., information in compliance with the one or more policies) to customers, and may also provide efficiency by avoiding post-conversation review for compliance purposes.

In certain embodiments, the contact center system 12 includes a configuration system 34. The configuration system 34 may be a routing system for the contact center system 12, and the configuration system 34 may dynamically route the customers to the automated agents and the human agents. The configuration system 34 may route the customers based on one or more factors, such as customer characteristics and/or contact center conditions. The customer characteristics may include intent provided by the customers (e.g., initial intent; determined based on a phone number or other path used to reach the contact center system 12; based on verbal inputs, such as during initial conversations; and/or based on customer data, accessed from one or more databases), predicted needs of the customers, and so forth. The contact center conditions may include call center volume, agent availability, agent queues, and so forth. The configuration system 34 may also monitor conversations to efficiently re-route (e.g., switch, handoff, return, transfer) the customers to another agent, such as from a particular automated agent to a particular human agent or vice versa.

As shown, the contact center system 12 may include a computing system 38 with a processor 40, memory 42, and/or storage 44. The processor 40 may be any type of computer processor or microprocessor capable of executing computer-executable code. Further, the processor 40 may be representative of or include multiple processors that are part of the computing system 38 and that may perform processing operations described herein. The memory 42 and the storage 44 may be any suitable article of manufacture that can serve to store processor-executable code, data, or the like. The article of manufacture may represent computer-readable media (e.g., any suitable form of memory or storage) that may store the processor-executable code used by the processor 40 to perform the presently disclosed techniques. Further, the memory 42 and the storage 44 may be representative of or include multiple memory devices and/or storage devices that are part of the computing system 38 and that may facilitate processing operations described herein. The memory 42 and the storage 44 may also store data (e.g., customer data), various software applications, and the like. It should be noted that non-transitory merely indicates that the media is tangible and not a signal.

The computing system 38 may also include other components, such as communication devices, input/output (I/O) ports, and/or output devices that operate to facilitate communication, inputs, and/or outputs described herein. In such cases, the communication devices may facilitate network communications (e.g., wired or wireless), the I/O ports may be interfaces that may communicatively couple to peripheral components, such as input devices (e.g., a keyboard, a mouse, a microphone), and the output devices may include one or more speakers and/or one or more displays (e.g., touch screen display) that function to provide relevant information to agents (e.g., the automated agents and/or the human agents).

It should be noted that the components described herein with regard to the computing system 38 are exemplary components and the computing system 38 may include additional or fewer components relative to what is shown and/or described. Additionally, as would be understood, it should be noted that any personal computing device (e.g., customer device and/or agent device) described herein may include components similar to those described as part of the computing system 38, such as a processor, memory, storage, communication device, I/O ports, output devices, and so forth. While certain operations are described as being performed by the computing system 38 to facilitate discussion, it should be appreciated that the operations may be divided in any suitable manner between the computing system 38 and any other suitable computing system having a processor (e.g., which may be collectively referred to as a processing system with one or more processors; a distributed computing system).

In operation, the contact center system 12 may provide conversation-based assistance to customers, such as a human customer 50. For example, the human customer 50 may utilize a customer device 52 (e.g., personal computing device; mobile phone) to contact the contact center system 12. The human customer 50 may utilize the customer device 52 to converse via verbal inputs (e.g., spoken inputs; phone call) and/or via text inputs (e.g., electronic mail messages; chat messages). The contact center system 12 may initially connect the human customer 50, via the customer device 52, to one of the automated intent agents 14 and/or to one of the human intent agents 16. In certain embodiments, the configuration system 34 may route the human customer 50 to one of the automated intent agents 14 or to one of the human intent agents 16 based on the customer characteristics of the human customer 50 (e.g., retrieved from the one or more databases) and/or based on the contact center conditions.

For example, the configuration system 34 may obtain a phone number of the human customer 50 upon receipt of a phone call from the human customer 50, and the configuration system 34 may access customer data for the human customer 50 based on the phone number of the human customer 50. The configuration system 34 may then determine that the human customer 50 should be connected to one of the human intent agents 16 (e.g., rather than one of the automated intent agents 14), such as based on customer characteristics that indicate the human customer 50 has a preference for human agents, has experienced failed communications with automated agents in prior phone calls, and so forth. Thus, in some cases, the configuration system 34 may place the human customer 50 in a queue for one of the human intent agents 16 even if the call center conditions indicate long wait times, high call volume, and so forth. As another example, the configuration system 34 may determine that the human customer 50 should be connected to one of the automated intent agents 14 (e.g., rather than one of the human intent agents 16), such as based on call center conditions that indicate no availability or low availability of the human intent agents 16.

The contact center system 12 may determine an intent of the human customer 50 based on a respective conversation between the human customer 50 and a selected intent agent of the automated intent agents 14 or the human intent agents 16. For example, the intent of the human customer 50 may be to obtain information, open an account, close an account, update an account, make an insurance claim, and so forth. Then, the configuration system 34 may determine that the human customer 50 should be connected to one of the automated transaction agents 20 or to one of the human transaction agents 22. In certain embodiments, the configuration system 34 may route the human customer 50 to one of the automated transaction agents 20 or to one of the human transaction agents 22 based on the customer characteristics of the human customer 50 (e.g., the intent and/or other customer data retrieved from the one or more databases) and/or based on the contact center conditions.

As noted herein, the configuration system 34 may determine that the human customer 50 should be connected to one of the human transaction agents 22 (e.g., rather than one of the automated transaction agents 20), such as based on customer characteristics that indicate the human customer 50 has a preference for human agents, has experienced failed communications with automated agents in prior phone calls, and so forth. Thus, in some cases, the configuration system 34 may place the human customer 50 in a queue for one of the human transaction agents 22 even if the call center conditions indicate long wait times, high call volume, and so forth. As another example, the configuration system 34 may determine that the human customer 50 should be connected to one of the automated transaction agents 20 (e.g., rather than one of the human transaction agents 22), such as based on call center conditions that indicate no availability or low availability of the human transaction agents 22.

The configuration system 34 may take into account capabilities of the automated transaction agents 20 and the human transaction agents 22. For example, the configuration system 34 may access and apply routing rules (e.g., policies; input by a human operator of the contact center system 12 and/or learned over time via machine learning algorithms) to connect the human customer 50 to an appropriate agent among the automated transaction agents 20 and the human transaction agents 22. The appropriate agent may be predicted or determined to be capable of assisting the human customer 50 based on the intent, the customer characteristics, and/or the call center conditions. For example, the appropriate agent may have specific training (e.g., exposure to specific training data sets) relevant to the intent.

In certain cases, the configuration system 34 may escalate the human customer 50 from the automated transaction agents 20 and the human transaction agents 22, such as to the automated expert agents 26 and/or the human expert agents 28. For example, a topic may arise during a respective conversation between the human customer 50 and the automated transaction agents 20 and/or the human transaction agents 22. The topic may result in the configuration system 34 automatically escalating the human customer 50, such as because the automated transaction agents 20 and/or the human transaction agents 22 may not have specific training relevant to the topic. In some embodiments, the automated expert agents 26 and/or the human expert agents 28 may have specific training relevant to the topic. For example, the topic may include or indicate fraud, and the automated expert agents 26 and/or the human expert agents 28 may have specific training relevant to handling fraud.

As noted herein, the configuration system 34 may determine that the human customer 50 should be connected to one of the human expert agents 28 (e.g., rather than one of the automated expert agents 26), such as based on customer characteristics that indicate the human customer 50 has a preference for human agents, has experienced failed communications with automated agents in prior phone calls, and so forth. For example, the configuration system 34 may implement a routing algorithm to route the human customer 50 according to the customer characteristics and/or other factors described herein. Thus, in some cases, the configuration system 34 may place the human customer 50 in a queue for one of the human expert agents 28 even if the call center conditions indicate long wait times, high call volume, and so forth. As another example, the configuration system 34 may determine that the human customer 50 should be connected to one of the automated expert agents 26 (e.g., rather than one of the human expert agents 28), such as based on call center conditions that indicate no availability or low availability of the human expert agents 28.

The configuration system 34 may take into account capabilities of the automated expert agents 26 and the human expert agents 28. For example, the configuration system 34 may access and apply routing rules (e.g., policies; input by a human operator of the contact center system 12 and/or learned over time via machine learning algorithms) to connect the human customer 50 to an appropriate agent among the automated expert agents 26 and the human expert agents 28. The appropriate agent may be predicted or determined to be capable of assisting the human customer 50 based on the intent, the topic, the customer characteristics, and/or the call center conditions. For example, the appropriate agent may have specific training (e.g., exposure to specific training data sets) relevant to the topic, as noted herein.

It should be appreciated that the configuration system 34 may also re-route the human customer 50 at any suitable time, such as based on the customer data and/or the call center conditions. For example, if the human customer 50 is initially routed to one of the human transaction agents 22, but the respective conversation indicates that the one of the human transaction agents 22 is failing to assist the human customer 50, then the configuration system 34 may re-route the human customer 50 to one of the automated transaction agents 20. As noted herein, the configuration system 34 may monitor the respective conversation and determine that the one of the human transaction agents 22 is failing to assist the human customer 50 based on various conversation factors, such as a length of the respective conversation exceeding a threshold, analysis of verbal inputs and/or text inputs via a language model, and/or analysis of tone of the human customer 50 and/or the one of the human transaction agents 22.

As another example, if the human customer 50 is initially routed to one of the automated transaction agents 20, but the respective conversation indicates that one or more human authorization actions is needed to complete a task for the human customer 50, then the configuration system 34 may re-route the human customer 50 to one of the human transaction agents 22. The one or more human authorization actions may include, for example, a signature on behalf of an entity that operates the contact center system 12. In some such cases, the configuration system 34 may re-route the human customer 50 back to the one of the automated transaction agents 20 after receipt of the one or more human authorization actions to thereby minimize time spent by the one of the human transaction agents 22. Thus, in certain embodiments, the human customer 50 may communicate with both the one of the automated transaction agents 20 and the one of the human transaction agents 22 during the respective conversation, but such conversations may be seamless (e.g., uninterrupted; continuous; without pauses or delays) from a perspective of the human customer 50. Similar routing and re-routing techniques may be applied within and/or across the multiple agents of the intent system 18, the transaction system 24, and/or the expert system 30. In FIG. 1, the various agents within the various systems may be arranged as peers (e.g., within the transaction system 24, all automated agents and all human agents are peers; similar training levels, such as similar training levels that enable conversations to complete tasks), while the various agents across the various systems are arranged in levels (e.g., within the expert system 30, all automated agents and all human agents are peers, but are considered to have higher training levels and/or advanced training on certain topics, such as fraud and/or other legal issues).

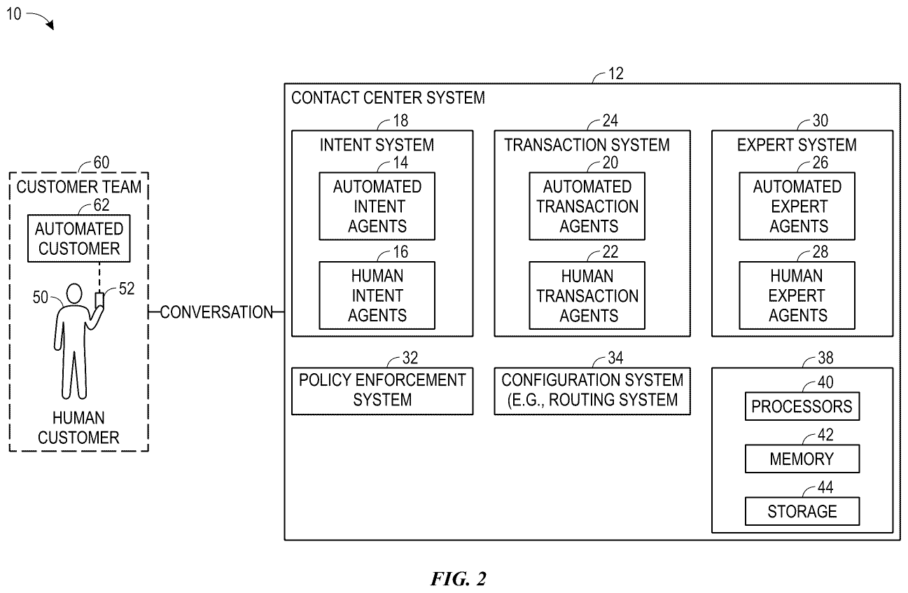

FIG. 2 is a schematic diagram of the autonomous contact center system 10 of FIG. 1, wherein the contact center system is configured to engage with a customer team 60 that includes an automated customer 62 and the human customer 50, in accordance with an embodiment. It is presently recognized that the human customer 50 may wish to assign or delegate certain tasks to a virtual assistant. Thus, the virtual assistant may operate as the automated customer 62 and may contact the contact center system 12 as a representative of the human customer 50. The virtual assistant, and thus the automated customer 62, may be implemented via a software application accessible to the human customer 50. For example, the software application may be stored on and accessible from the customer device 52.

Because the contact center system 12 provides conversation-based assistance, the contact center system 12 may be configured to directly interact with the human customer 50 and also indirectly interact with the human customer 50 via the automated customer 62. In certain embodiments, the contact center system 12 may interact in a same or similar manner with the human customer 50 and the automated customer 62. Thus, the contact center system 12 may interact with the automated customer 62 in a same or similar manner as described with respect to the human customer 50 in FIG. 1, for example. In operation, the human customer 50 may instruct the automated customer 62 to contact the contact center system 12 to carry out a task, such as to obtain information, open an account, close an account, update an account, make an insurance claim, and so forth. Then, the automated customer 62 may contact the contact center system 12, such as via the customer device 52 or other communication path, to converse via verbal inputs (e.g., spoken inputs; phone call) and/or via text inputs (e.g., electronic mail messages; chat messages). Then, the contact center system 12 may route the automated customer 62 through the intent system 18, the transaction system 24, and/or the expert system 30 to complete the task.

In certain embodiments, the contact center system 12 may identify and/or detect that the contact or communication is with the automated customer 62 (e.g., rather than the human customer 50). For example, the automated customer 62 may identify itself as the representative of the human customer 50. Additionally or alternatively, the contact center system 12 may detect automation signatures in the communication with the automated customer 62 (e.g., cadence, tone, and/or other audible speech elements indicative of participation of the automated customer 62 in the communication). In certain embodiments, the contact center system 12 may adjust certain operations in response to identifying that the contact or communication is with the automated customer 62 (e.g., rather than the human customer 50). For example, the contact center system 12 may operate the automated agents 14, 20, 26 and/or instruct the human agents 16, 22, 28 to communicate in a more efficient manner in response to identifying that the contact or communication is with the automated customer 62 (e.g., rather than the human customer 50; communicate in a more efficient manner as compared to during communication with the human customer 50). For example, the contact center system 12 may operate the automated agents 14, 20, 26 and/or instruct the human agents 16, 22, 28 to communicate at a faster rate (e.g., words per time period) in response to identifying that the contact or communication is with the automated customer 62 (e.g., rather than the human customer 50; communicate at the faster rate as compared to during communication with the human customer 50). In certain embodiments, the contact center system 12 may operate the automated agents 14, 20, 26 and/or instruct the human agents 16, 22, 28 to communicate with different words and phrases in response to identifying that the contact or communication is with the automated customer 62 (e.g., rather than the human customer 50; communicate with different words and phrases as compared to during communication with the human customer 50) to facilitate efficient processing of the communication by the automated customer 62.

Further, if a conversation indicates that one or more human authorization actions is needed to complete the task during the communication with the automated customer 62, then the contact center system 12 may instruct the automated customer 62 to notify the human customer 50. The one or more human authorization actions may include, for example, a signature by the human customer 50, an authentication of the human customer 50 (e.g., biometric data), spoken interaction to address potential fraud, and so forth. In some such cases, the contact center system 12 may permit the automated customer 62 to continue or conclude the conversation after receipt of the one or more human authorization actions to thereby minimize time spent by the human customer 50. Thus, in certain embodiments, the contact center system 12 may communicate with both the automated customer 62 and the human customer 50 during the conversation.

The automated customer 62, in conjunction with the contact center system 12, may notify the human customer 50 in any of a variety of ways. For example, the automated customer 62 may notify the human customer 50 via a pop-up notification on the customer device 52, a phone call to the customer device 52 to prompt the human customer 50 to answer to join the conversation with the contact center system 12, an automated meeting invitation for a future time for the human customer 50 to interact with the contact center system, and so forth.

In some embodiments, the human customer 50 may set forth a list of tasks for the automated customer 62 to perform over time (e.g., periodically, upon certain events). For example, the human customer 50 may instruct the automated customer 62 to contact the contact center system 12 annually to obtain information about an account and to contact the contact center system 12 bi-annually to negotiate insurance costs on behalf of the human customer 50. Then, the automated customer 62 may automatically perform the tasks according to the instructions, with or without notifying the human customer 50 prior to contacting the contact center system 12.

In some embodiments, the automated customer 62 may monitor (e.g., via the virtual assistant and/or related monitoring systems) task-related changes for the human customer 50, such as a change in income via monitoring financial accounts, a change in vehicle ownership via monitoring credit accounts, a change in insurance needs via monitoring family data, and so forth. In such cases, the automated customer 62 may automatically determine tasks to complete and also automatically contact the contact center system 12 to perform the tasks, with or without notifying the human customer 50 prior to contacting the contact center system 12.

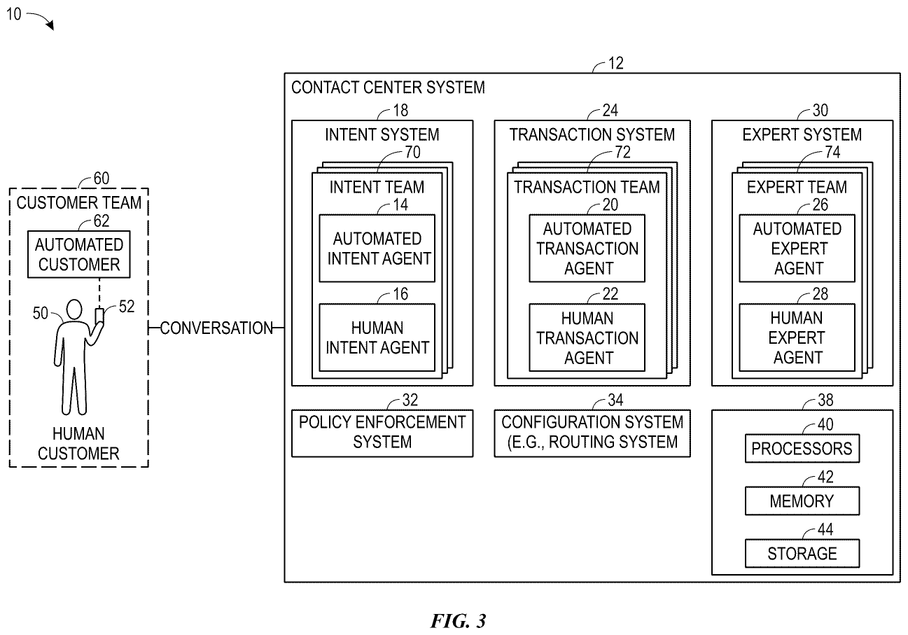

FIG. 3 is a schematic diagram of the autonomous contact center system 10 of FIG. 1, wherein the contact center system 12 includes the automated agents and the human agents arranged in teams, in accordance with an embodiment. In particular, the contact center system 12 may include the intent system 18 with multiple intent teams 70, and each intent team includes one or more automated intent agents 14 and one or more human intent agents 16. Further, the contact center system 12 may include the transaction system 24 with multiple transaction teams 72, and each transaction team includes one or more automated transaction agents 20 and one or more human transaction agents 22. Further, the contact center system 12 may include the expert system 30 with multiple expert teams 74, and each expert team includes one or more automated expert agents 26 and one or more human expert agents 28.

The contact center system 12 is shown to be in communication with the customer team 60 via the customer device 52, wherein the customer team 60 includes the human customer 50 and the automated customer 62. However, it should be appreciated that the contact center system 12 may also be configured to communicate with the human customer 50 (e.g., as shown in FIG. 1, when the human customer 50 is not part of the customer team 60 and/or does not utilize the automated customer 62). Indeed, as used herein, “a customer” or “the customer” may refer to the human customer 50, the automated customer 62, and/or the customer team 60.

The contact center system 12 may arrange the various agents into the teams to facilitate efficient routing and assistance to the customer team 60. For example, within each team, the one or more automated agents and the one or more human agents may be trained to complete one or more particular tasks (e.g., one transaction team may be trained to complete account opening tasks, and another transaction team may be trained to complete insurance claim tasks). Thus, the configuration system 34 may determine that the customer team 60 should be routed to a particular transaction team based on the intent. Then, within the particular transaction team, the configuration system 34 may connect the customer team 60 to one human transaction agent if available, or otherwise to one automated transaction agent. Further, as the conversation progresses or continues, the configuration system 34 may re-route the customer team 60 to other agents (e.g., from human to automated, or vice versa) within the particular transaction team. Further, the configuration system 34 route the customer team 60 into a joint mode (e.g., in which the human transaction agent and the automated transaction agent work together to converse with the customer team 60), as a combination of automated and human inputs may be appropriate to address the task. For example, the customer team 60 may converse with the human transaction agent, and the automated transaction agent may listen and contribute via spoken inputs (e.g., audible to the human transaction agent and/or the customer team 60) and/or text inputs (e.g., visible to the human transaction agent and/or the customer team 60). As another example, the customer team 60 may converse with the automated transaction agent, and the human transaction agent may listen and contribute via spoken inputs (e.g., audible to the human transaction agent and/or the customer team 60) and/or text inputs (e.g., visible to the human transaction agent and/or the customer team 60). In this way, a secondary agent may provide support to guide a primary agent during an interaction with the customer team 60.

It should be appreciated that each team may include one automated agent per human agent, multiple automated agents per human agent, and/or multiple human agents per automated agent. For example, one automated agent may pair with a first human agent to provide support a portion of one phone call, and then the one automated agent may then pair with a second human agent to provide support during a portion of another phone call. Further, the configuration system 34 may generate automated agents and/or rearrange any of the agents based on call center conditions. For example, the configuration system 34 may bring additional automated agents online during high volume, such as during no or low availability of human agents and automated agents.

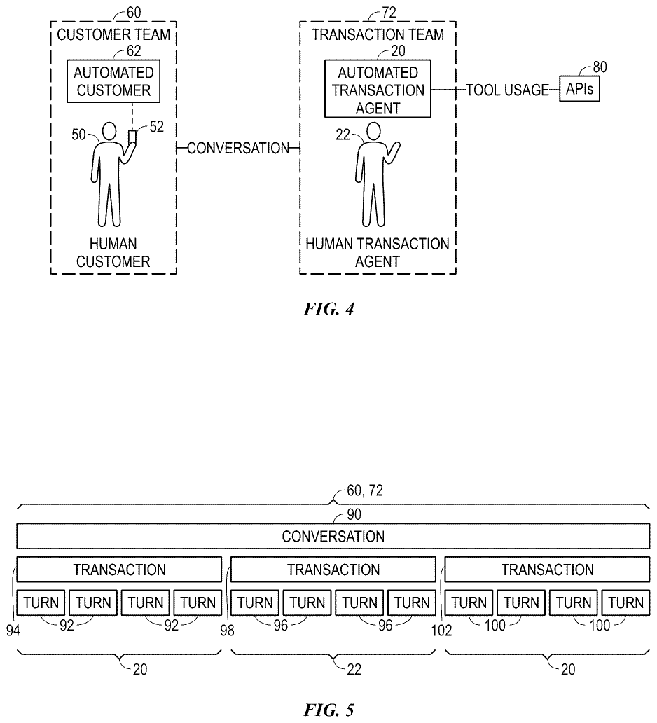

FIG. 4 is a schematic diagram that represents an example conversation that may be carried out by the autonomous contact center system 10 of FIG. 1, wherein a transaction team 72 utilizes an automated transaction agent 20, a human transaction agent 22, or both to complete a task for the human customer 50 of the customer team 60, in accordance with an embodiment. The transaction team 72 is shown to be in communication with the customer team 60 via the customer device 52, wherein the customer team 60 includes the human customer 50 and the automated customer 62. However, it should be appreciated that the transaction team 72 may also be configured to communicate with the human customer 50 (e.g., as shown in FIG. 1, when the human customer 50 is not part of the customer team 60 and/or does not utilize the automated customer 62).

In operation, the customer team 60 may contact the contact center system 12 (FIG. 1), and the customer team 60 may be routed to and/or connected with the transaction team 72. For example, the customer team 60 may be connected with the transaction team 72 based on the intent of the customer team 60 and relevant skills of the transaction team 72 (e.g., due to the transaction team 72 being trained on data sets that enable the transaction team 72 to carry out a task to address the intent of the customer team 60).

As described herein, the customer team 60 may be connected to the automated transaction agent 20, the human transaction agent 22, or both (e.g., a selected transaction agent). The selected transaction agent may carry out a conversation with the customer team 60. In certain embodiments, the transaction team 72 may access a tool, such as one or more application programming interfaces (APIs) 80. The transaction team 72 may use the one or more APIs 80 to guide the conversation with the customer team 60, such as to request certain information from the customer team 60, provide certain information to the customer team, and so forth in order to complete the task to address the intent of the customer team 60.

Notably, the transaction team 72 may be trained based on the one or more APIs 80. For example, the one or more APIs 80 may be adapted to train large language models (LLMs), and generative artificial intelligence may be utilized to enable the automated transaction agent 20 to maintain the conversation with the customer team 60 and use information extracted from the conversation. For example, the automated transaction agent 20 may use the information to access a particular API of the one or more APIs 80, and then to request certain information and provide certain information accordingly.

FIG. 5 is a schematic diagram that represents an example conversation that may be carried out by the autonomous contact center system 10 of FIG. 1, wherein the transaction team 72 switches between the automated transaction agent 20 and the human transaction agent 22 to interact with the customer team 60, in accordance with an embodiment. The transaction team 72 is shown to be in communication with the customer team 60; however, it should be appreciated that the transaction team 72 may also be configured to communicate with the human customer 50 (e.g., as shown in FIG. 1, when the human customer 50 is not part of the customer team 60 and/or does not utilize the automated customer 62 of FIGS. 2-4).

As described herein, the customer team 60 may be routed to engage or interact with certain agents, such as a team of agents. To facilitate discussion, FIG. 5 illustrates a conversation 90 between the customer team 60 and the transaction team 72. In certain cases, the customer team 60 may initially be routed to or connected with the automated transaction agent 20 of the transaction team 72, such as based on the customer characteristics and/or the call center conditions. As such, the automated transaction agent 20 and the customer team 60 may take turns 92 to exchange information as a first transaction 94 (e.g., a first portion of the conversation 90).

Further, as the conversation progresses or continues, it may be desirable to re-route the customer team 60 to another agent, such as to the human transaction agent 22 that is part of the transaction team 72. As described herein, this may be carried out to facilitate one or more human authentication actions, or for any of a variety of other reasons. As such, the human transaction agent 22 and the customer team 60 may take turns 96 to exchange additional information as a second transaction 98 (e.g., a second portion of the conversation 90).

In certain embodiments, it may be desirable to re-route the customer team 60 to another agent, such as to return to the automated transaction agent 20 that is part of the transaction team 72. As described herein, this may be carried out to complete the task following the one or more human authentication actions, or for any of a variety of other reasons. As such, the automated transaction agent 20 and the customer team 60 may take turns 100 to exchange additional information as a third transaction 102 (e.g., a third portion of the conversation 90).

It should be appreciated that the customer team 60 may be re-routed in any of a variety of manners, such as from the automated transaction agent 20 and/or the human transaction agent 22 to one of the automated expert agents 26 and/or one of the human expert agents 28, for example. Further, it should be appreciated that the customer team 60 may switch between the human customer 50 and the automated customer 62 at any suitable time. For example, the automated customer 62 may carry out the first transaction 94, while the human customer 50 may carry out the second transaction 98, and then the automated customer 62 may carry out the third transaction 102.

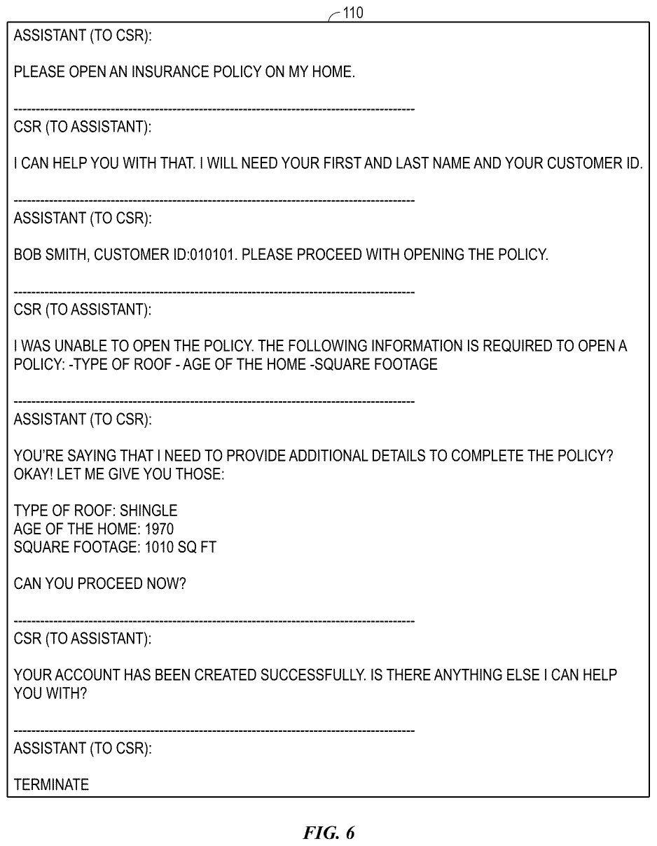

FIG. 6 is an example conversation that may be carried out by the autonomous contact center system 10 of FIG. 1, wherein the transaction team 72 of FIG. 4 utilizes the automated transaction agent 20, the human transaction agent 22, or both to interact with the automated customer 62 of the customer team 60 of FIG. 4, in accordance with an embodiment. As shown, the automated customer 62 may initiate a conversation 110 on behalf of the human customer 50, such as by stating an indication of intent (e.g., “Please open an insurance policy on my home.”). The transaction team 72 may access the one or more APIs 80, as shown in FIG. 4, to guide the conversation 110. For example, the transaction team 72 may determine that the customer team 60 should provide certain information in order to complete a task to address the intent. Thus, the transaction team 72 may prompt the automated customer 62 to provide the information, such as an identifier of the human customer 50 and/or specifications of a property associated with the human customer 50.

The automated customer 62 may have access to the information or may otherwise be able to notify the human customer 50 to provide the information. In this way, the transaction team 72 and the automated customer 62 may complete the task to address the intent, such as open an account, close an account, update an account, make an insurance claim, and so forth. As used herein, the account may refer to a membership account, a financial account, an insurance account (e.g., policy), or any other suitable type of account or policy. As described herein, the conversation 110 may be carried out via verbal inputs (e.g., phone call) and/or text inputs (e.g., electronic mail, text messages). In some cases, the conversation 110 may be transcribed (e.g., from spoken to text), presented on a display (e.g., for visualization by the human customer 50, the automated customer 62, and/or appropriate agents and/or systems in the contact center system 12), and/or recorded (e.g., stored for future reference and/or analysis, such as for compliance review and/or as training data). For example, the conversation 110 as shown in FIG. 6 may be presented on a display.

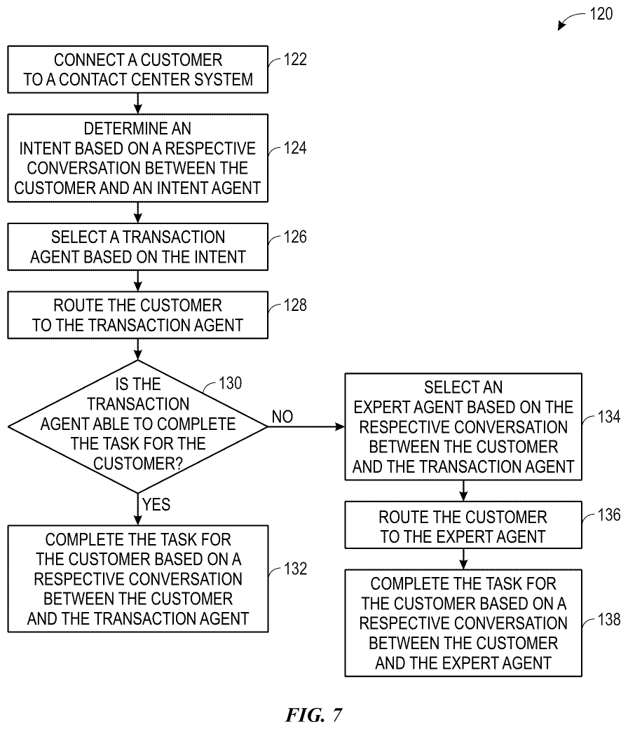

FIG. 7 is a flow diagram of a method 120 of operating an autonomous contact center system (e.g., the autonomous contact center system of FIG. 1) to route a customer to one or more automated agents, one or more human agents, or both based on conversation inputs, in accordance with an embodiment. The method 120 is described as being performed by a processing system (e.g., the computing system 38), but it should be noted that any suitable processor-based device or system may be specially programmed to perform any of the methods described herein. Moreover, although the method 120 is described as including certain blocks performed in a particular order, it should be understood that the blocks of the method 120 may be performed in any suitable order, that certain blocks may be omitted, and/or that certain blocks may be added.

In block 122, the method 120 may include connecting a customer to a contact center system. For example, the customer may utilize a customer device or other suitable device to contact the contact center system. The customer may converse via verbal inputs (e.g., spoken inputs; phone call) and/or via text inputs (e.g., electronic mail messages; chat messages). In certain embodiments, the contact center system may initially connect the customer to an intent agent, such as an automated intent agent and/or a human intent agent.

In block 124, the method 120 may include determining an intent based on a respective conversation between the customer and the intent agent. For example, the computing system may employ language processing algorithms to analyze the respective conversation to determine the intent. The intent of the human customer may be to obtain information, open an account, close an account, update an account, make an insurance claim, and so forth.

In block 126, the method 120 may include selecting a transaction agent, such as an automated transaction agent and/or a human transaction agent, based on the intent. In certain embodiments, the computing system may route the customer to the transaction agent based on the intent and other customer characteristics (e.g., customer data retrieved from the one or more databases), the contact center conditions, and/or capabilities of the transaction agent. In block 128, the method 120 may include routing the customer to the transaction agent.

In block 130, the method 120 may include determining whether the transaction agent is able to complete a task for the customer based on a respective conversation between the customer and the transaction agent. If it is determined that the transaction agent is able to complete the task for the customer, then in block 132, the method 120 may include completing the task for the customer based on the respective conversation between the customer and the transaction agent.

However, if it is determined that the transaction agent is not able to complete the task for the customer, then in block 134, the method 120 may include selecting an expert agent, such as an automated expert agent and/or a human expert agent, based on the respective conversation between the customer and the transaction agent. For example, the computing system may identify a deficiency with respect to particular subject matter (e.g., due to lack of relevant training), and the computing system may select the expert agent based on a proficiency with respect to the particular subject matter (e.g., due to relevant training). The computing system may escalate the customer from the transaction agent to the expert agent under circumstances, such as if a topic arises during the respective conversation between the customer and the transaction agent. For example, the topic may include or indicate fraud, and the expert agent may have specific training relevant to handling fraud. In block 136, the method 120 may include routing the customer to the transaction agent. Then in block 138, the method 120 may include completing the task for the customer based on a respective conversation between the customer and the expert agent. It should be appreciated the expert agent may not necessarily complete the task, but may resolve certain aspects that then enables re-routing the customer back to the transaction agent to complete the task.

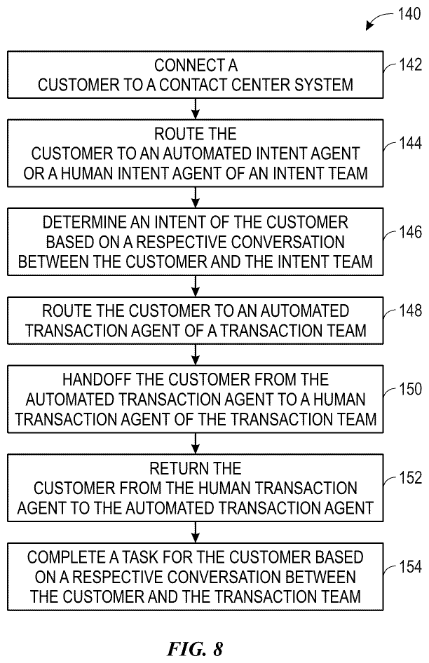

FIG. 8 is a flow diagram of a method 140 of operating an autonomous contact center system (e.g., the autonomous contact center system of FIG. 1) to transfer a customer between an automated transaction agent and a human transaction agent to complete a task for the customer, in accordance with an embodiment. The method 140 is described as being performed by a processing system (e.g., the computing system 38), but it should be noted that any suitable processor-based device or system may be specially programmed to perform any of the methods described herein. Moreover, although the method 140 is described as including certain blocks performed in a particular order, it should be understood that the blocks of the method 140 may be performed in any suitable order, that certain blocks may be omitted, and/or that certain blocks may be added.

In block 142, the method 140 may include connecting a customer to a contact center system. For example, the customer may utilize a customer device or other suitable device to contact the contact center system. The customer may converse via verbal inputs (e.g., spoken inputs; phone call) and/or via text inputs (e.g., electronic mail messages; chat messages).

In block 144, the method 140 may include routing the customer to an automated intent agent and/or a human intent agent. As described herein, the automated intent agent and/or the human intent agent may be arranged in an intent team. In block 146, the method 140 may include determining an intent (e.g., initial intent) based on a respective conversation between the customer and the intent team. For example, the computing system may employ language processing algorithms to analyze the respective conversation to determine the intent. The intent of the human customer may be to obtain information, open an account, close an account, update an account, make an insurance claim, and so forth.

In block 148, the method 140 may include selecting and routing the customer to an automated transaction agent. As described herein, the automated transaction agent may be part of a transaction team. In certain embodiments, the computing system may route the customer to the automated transaction agent based on the intent and other customer characteristics (e.g., customer data retrieved from the one or more databases), the contact center conditions, and/or capabilities of the transaction agent.

In block 150, the method 140 may include re-routing (e.g., handing off) the customer to a human transaction agent. As described herein, the human transaction agent may be part of the transaction team. For example, the computing system may determine that based on the respective conversation between the customer and the automated transaction agent, one or more human authorization actions are needed to complete a task for the customer. Accordingly, the computing system may re-route the customer to the human transaction agent so that the human transaction agent can provide a signature on behalf of an entity that operates the contact center system and/or carry out other suitable actions.

In block 152, the method 140 may include re-routing (e.g., returning) the customer back to the automated transaction agent after receipt of the one or more human authorization actions to thereby minimize time spent by the human transaction agent. Thus, in certain embodiments, the customer may communicate with both the automated transaction agent and the human transaction agent during the respective conversation. Then in block 154, the method 140 may include completing the task for the customer based on the respective conversation between the customer and the transaction team.

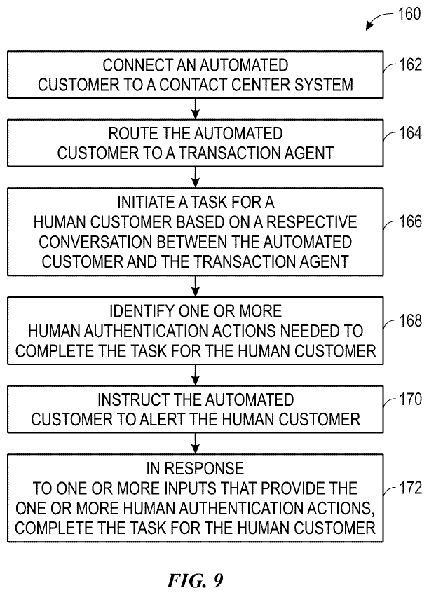

FIG. 9 is a flow diagram of a method 160 of operating an autonomous contact center system to engage with an automated customer that is associated with a human customer, in accordance with an embodiment. The method 160 is described as being performed by a processing system (e.g., the computing system 38), but it should be noted that any suitable processor-based device or system may be specially programmed to perform any of the methods described herein. Moreover, although the method 160 is described as including certain blocks performed in a particular order, it should be understood that the blocks of the method 160 may be performed in any suitable order, that certain blocks may be omitted, and/or that certain blocks may be added.

In block 162, the method 160 may include connecting an automated customer to a contact center system. The automated customer may be associated with a human customer (e.g., may be a virtual assistant for the human customer) and contact the contact center system on behalf of the human customer. For example, the automated customer may utilize a customer device or other suitable device to contact the contact center system. The automated customer may converse via verbal inputs (e.g., spoken inputs; phone call) and/or via text inputs (e.g., electronic mail messages; chat messages).

In block 164, the method 160 may include selecting and routing the customer to a transaction agent, such as an automated transaction agent and/or a human transaction agent. In certain embodiments, the computing system may route the customer to the transaction agent based on the intent and other customer characteristics (e.g., customer data retrieved from the one or more databases), the contact center conditions, and/or capabilities of the transaction agent. In block 166, the method 160 may include initiating a task for the human customer based on a respective conversation between the automated customer and the transaction agent. For example, the automated customer and the transaction agent may exchange information relevant to the task.

In block 168, the method may include identifying one or more human authorization actions that may be utilized or are needed to complete the task. The one or more human authorization actions may include, for example, a signature by the human customer, an authentication of the human customer (e.g., biometric data), spoken interaction to address potential fraud, and so forth. In block 170, the method 160 may include instructing the automated customer to notify the human customer. For example, the computing system may notify the automated customer, and the automated customer may cause the mobile device to ring to prompt the human customer to join the respective conversation with the transaction agent, may provide a pop-up notification with a link to a webpage so that the human customer can efficiently provide an electronic signature, and so forth. It should be appreciated than any of a variety of communication pathways and/or notification styles are envisioned in order to facilitate entry of the one or more human authorization actions by the human customer.

In block 172, the method 160 may include completing the task in response to receipt of the one or more human authorization actions. In some embodiments, the computing system may return to the respective conversation between the automated customer and the transaction agent to complete the task, which may minimize time spent by the human customer. Thus, in certain embodiments, the contact center system may communicate with both the automated customer and the human customer during the respective conversation.

Advantageously, techniques described herein provide multiple teams and layers of agents (e.g., automated agents and human agents) to assist customers. Further, techniques described herein provide an ability to efficiently conduct conversations between various parties, including human customers, automated customers (e.g., virtual assistants associated with the human customers), human agents, and/or automated agents.

While only certain features of the disclosure have been illustrated and described herein, many modifications and changes will occur to those skilled in the art. It is, therefore, to be understood that the appended claims are intended to cover all such modifications and changes as fall within the true spirit of the disclosure. It should be appreciated that any features described or shown with respect to FIGS. 1-9 may be combined in any suitable manner.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. An autonomous contact center system, comprising:
a computing system comprising one or more processors; and
memory storing instructions that, when executed by the computing system, cause the computing system to:
route a customer to an automated transaction agent;
determine a task to complete based on a conversation between the customer and the automated transaction agent;
instruct the automated transaction agent to request that the customer provide additional information relevant to the task; and
in response to determining that the customer is unable to provide the additional information relevant to the task, provide an output to prompt a human input.

2. The autonomous contact center system of claim 1, wherein the customer comprises an automated customer that represents a human customer.

3. The autonomous contact center system of claim 2, wherein the instructions, when executed by the computing system, cause the computing system to:
in response to determining that the customer is unable to provide the additional information relevant to the task, provide the output to cause the automated customer to prompt the human input by the human customer.

4. The autonomous contact center system of claim 1, wherein the instructions, when executed by the computing system, cause the computing system to:
in response to determining that the customer is unable to provide the additional information relevant to the task, provide the output to cause the automated transaction agent to prompt the human input by a human transaction agent.

5. The autonomous contact center system of claim 4, wherein the instructions, when executed by the computing system, cause the computing system to:
in response to determining that the customer is unable to provide the additional information relevant to the task, provide the output to cause the automated transaction agent to prompt the human input by enabling communication between the customer and the human transaction agent.

6. The autonomous contact center system of claim 4, wherein the automated transaction agent and the human transaction agent are arranged in a team trained on a subset of tasks handled by the autonomous contact center system.

7. The autonomous contact center system of claim 1, wherein the instructions, when executed by the computing system, cause the computing system to:
in response to determining that the automated transaction agent is unable to complete the task, route the customer to an automated expert agent, wherein the automated transaction agent and the automated expert agents are trained on different training data sets.

8. The autonomous contact center system of claim 1, wherein the instructions, when executed by the computing system, cause the computing system to:
determine an initial intent of the customer based on an initial conversation between the customer and an automated intent agent; and
route the customer to the automated transaction agent based on the initial intent.

9. An autonomous contact center system, comprising:
a computing system comprising one or more processors; and
memory storing instructions that, when executed by the computing system, cause the computing system to:
route an automated customer associated with a human customer to an automated transaction agent, a human transaction agent, or both;
determine a task to complete based on a conversation between the automated customer and the automated transaction agent, the human transaction agent, or both; and
complete the task based on the conversation between the automated customer and the automated transaction agent, the human transaction agent, or both.

10. The autonomous contact center system of claim 9, wherein the instructions, when executed by the computing system, cause the computing system to analyze the conversation using a language processing algorithm to determine the task to complete, gather relevant information to complete the task, or both.

11. The autonomous contact center system of claim 9, wherein the instructions, when executed by the computing system, cause the computing system to instruct the automated customer to provide a notification to the human customer to request one or more human inputs to complete the task.

12. The autonomous contact center system of claim 11, wherein the one or more human inputs comprise one or more authentication inputs to authenticate the human customer, one or more authorization inputs to confirm authorization of the task by the human customer, or any combination thereof.

13. The autonomous contact center system of claim 9, wherein the instructions, when executed by the computing system, cause the computing system to:
determine an initial intent of the automated customer based on an initial conversation between the automated customer and an automated intent agent;
route the automated customer to the automated transaction agent based on the initial intent;
determine the task to complete based on the conversation between the automated customer and the automated transaction agent; and
complete the task based on the conversation between the automated customer and the automated transaction agent.

14. The autonomous contact center system of claim 9, comprising a customer device that enables the human customer to instruct the automated customer to contact a contact center system on behalf of the human customer.

15. The autonomous contact center system of claim 9, wherein the task comprises an account opening, an account closing, an account update, an insurance claim, or any combination thereof.

16. A method of operating an autonomous contact center system, the method comprising:
routing, using one or more processors, an automated customer to an automated transaction agent;
determining, using the one or more processors, a task to complete based on a conversation between the automated customer and the automated transaction agent;
instructing, using the one or more processors, the automated transaction agent to request that the automated customer provide additional information relevant to the task; and
completing, using the one or more processors, the task based on the conversation and the additional information.

17. The method of claim 16, comprising analyzing, using the one or more processors, the conversation using a language processing algorithm to determine the task to complete, gather relevant information to complete the task, or both.

18. The method of claim 16, comprising determining, using the one or more processors, participation of the automated customer in the conversation based on analysis of audible speech by the automated customer.

19. The method of claim 16, comprising instructing, using the one or more processors, the automated customer to provide a notification to a human customer to request one or more human inputs to complete the task.

20. The method of claim 16, comprising instructing, using the one or more processors, a customer device to output a notification to indicate completion of the task.
